(19) United States
(12) Patent Application Publication
(10) Pub. No.: US 2025/0110884 A1
(43) Pub. Date: Apr. 3, 2025

(54) Selective Transfer of Cache Block Data

(71) Applicant: Advanced Micro Devices, Inc., Santa Clara, CA (US)

(72) Inventors: Shaizeen Dilawarhusen Aga, Santa Clara, CA (US); Nuwan S. Jayasena, Cupertino, CA (US); Michael J. Schulte, Austin, TX (US); Srilatha Manne, Seattle, WA (US)

(73) Assignee: Advanced Micro Devices, Inc., Santa Clara, CA (US)

(21) Appl. No.: 18/477,941

(22) Filed: Sep. 29, 2023

(51) Int. Cl. G06F 12/0891; G06F 12/0877

(52) U.S. Cl. CPC G06F 12/0891; G06F 12/0877

(57) ABSTRACT

Systems and techniques for selectively transferring one or more portions of a cache block in response to a request are described. Computing system components are informed as to instances where data transfer operations involve moving less than an entirety of data included in a cache block cache block. In one example, executable code for a computational task includes hints that identify when memory requests involve accessing and transmitting less than an entirety of a cache block and cause system components to communicate a subset of the cache block during a memory access. In another example, a data differentiator unit is implemented to analyze a cache block and return a portion of the cache block that is selected based on one or more criteria specified for a computational task. The described techniques thus overcome conventional drawbacks facing systems that transmit an entire cache block when only a portion is needed.

### BACKGROUND

Memory devices and associated memory controllers are employed by computing systems to manage data storage and control how data is made available to processing devices, such as central processing units, graphics processing units, auxiliary processing units, parallel accelerated processors, and so forth. As such, efficiency in data communication directly affects operation of these devices, examples of which include processing speed, bandwidth, and power consumption. Conventional techniques for data transfer, however, involve transmitting data at a coarse granularity (e.g., transmitting an entire cache block of data), with the optimistic assumption that doing so will allow a processing device to perform computations using all of the transmitted data. Conventional data transfer systems and techniques thus result in decreased performance and inefficiencies in scenarios where less than an entirety of a data block is used for a computational task.

### BRIEF DESCRIPTION OF THE DRAWINGS

FIG. 1 is a block diagram of a non-limiting example system having a device that implements a processing unit and memory module to implement the selective cache block data transfer techniques described herein.

FIG. 2 is a block diagram of a non-limiting example system showing the device of FIG. 1 in greater detail as employing a data differentiator unit at one or more device components to implement the selective cache block data transfer techniques described herein.

FIG. 3 is a block diagram of a non-limiting example system showing operation of a memory controller of FIG. 1 in greater detail as generating a partial cache block request based on a selective transfer hint included in a memory request.

FIG. 4 is a block diagram of a non-limiting example system showing operation of a memory controller of FIG. 1 in greater detail as returning a partial cache block in response to a memory request based on analysis of data included in a cache block retrieved from memory.

FIG. 5 is a block diagram of a non-limiting example procedure describing performance of selectively transferring a portion of data included in a cache block in response to a memory request.

### DETAILED DESCRIPTION

Conventionally, computing device system architectures leverage one or more processing units to perform computational tasks by processing data stored in memory. When performing a computational task, data is retrieved from the memory and transferred through one or more communication channels to a local cache that is accessible by the one or more processing units. When stored in memory, data is conventionally stored in a cache block (also commonly referred to as a cache line or a cache slot), which refers to a contiguous range of addresses in memory. In conventional computing device architectures, when a processing unit accesses data from the memory, instead of fetching specific bits of data that are involved in performing a computational task, the processing unit fetches an entire cache block of data that includes the specific bits of data needed for the computational task.

Thus, in a conventional system architecture where a processing unit needs 256 bits of data for a given computational operation, the host processor transmits a request for a data block in memory that includes that 256 bits of data. Despite the request only involving 256 bits of data, conventional system architectures translate this request to identify which chunk (e.g., cache block) of memory includes the requisite 256 bits of data. If this conventional system architecture stores data in a cache block size of 512 bits, the memory request would involve the entire cache block of 512 bits of data being retrieved from memory and communicated to a local cache that is accessible by the processing unit. After the entire 512-bit cache block of data is written to the local cache, the processing unit retrieves the 256 bits of data that were actually needed to perform the computational operation.

Such a conventional architecture and data transfer technique results from conventional computing system designs being optimistic about data transfer and assuming that if a request is received, for example, for eight bits of data, it is predicted that a subsequent request will need the next eight bits, and so forth. Such an optimistic assumption thus results in system architectures being designed to transfer an entire cache block for a request that involves a subset of data stored in the cache block. However, with advances in computing device technology, such serialized use of data is not always performed, which results in computational inefficiencies and delay. For instance, each bit of data transferred between components of a computing system (e.g., from system memory to a cache system to a processing unit, etc.) involves consumption of power by the computing system and consumes limited bandwidth on a communication network that couples the system components. Accordingly, transferring even one bit of unnecessary data reduces system optimization by unnecessarily consuming excess power, reducing available bandwidth, and requiring extra time to communicate data when responding to a request. When scaled to a system that handles numerous (e.g., billions) of requests, these system inefficiencies become significantly pronounced.

To address these conventional shortcomings, systems and techniques for selectively transferring one or more portions of a cache block in response to a request are described. The techniques are configured to inform each system component (e.g., processing device, cache system, memory controller, memory module, and so forth) as to how many bits of data are actually being requested by a memory request and thus informing system components as to instances (e.g., system clock cycles, memory accesses, etc.) where data transfer operations will involve moving less than an entirety of a cache block. For instance, in an example scenario where a system typically transmits an entire cache block of 64 bytes in a standard memory access, the described techniques inform system components that for a given memory access only 16 bytes of data will be transmitted. By informing system components as to the specific amount of data that will be transmitted during a given memory access, the described techniques enable selective data access and transmission (e.g., only 16 byes of a 64-byte cache block are retrieved from memory and communicated via a data bus, via a network-on-chip, combinations thereof, and so forth), which avoids the latency and energy cost that would otherwise result in a conventional system architecture that transmits the entire 64-byte cache block in response to a memory request for only the 16 bytes of data required for a computational task.

For instance, in a system architecture where a cache system includes a cache that is divided into four different arrays, such a four-array division enables data transfer parallelism in scenarios where the entire cache is able to store more data than can be communicated between system components during a given system memory access. As a specific example, consider a system architecture where a cache includes four different arrays and the system stores data in memory at a cache block size of 512 bits. Continuing this specific example, each of the cache's four arrays is configured to store 25% of the cache block (e.g., 128 bits of data) and the system architecture limits data communication between memory and the cache system to 128 bits of data per memory access.

By segmenting the cache into four 128-bit arrays, the system architecture enables for convenient assignment, of data retrieved from memory in a given computational cycle or over multiple computational cycles, to a corresponding array. Continuing this specific example, if during a first clock cycle a first 25% of a cache block is read from memory, the first 25% of the cache block is written to a first cache array. During a second clock cycle the second 25% of the cache block is written to a second cache array, during a third clock cycle the third 25% of the cache block is written to a third cache array, and during a fourth clock cycle the final 25% of the cache block is written to a fourth cache array. However, if in this specific example only the first 128 bits of data are actually needed to perform a computational task, conventional system architectures unnecessarily consume the second, third, and fourth clock cycles of the specific example by transferring data unnecessarily.

The techniques described herein are configured to inform the system components (e.g., the memory, the cache system, and the processing unit that accesses data from the cache system) as to an amount of data from a cache block that should be transferred during a given memory access (e.g., during a read access, a write access, or a combination thereof). In implementations, information describing that the amount of data to be transferred during a given memory access is less than an entire cache block of data is explicitly specified via executable code for a computational task performed by a computing system. For instance, in some implementations a programmer (e.g., an application developer) includes specific hints in executable code for a computational task that specifies when a request for data stored in memory is for a subset of data included in a cache block, rather than for the entirety of the cache block as associated with conventional memory requests. In such an example, when performing one or more operations of a computational task, a host processor is informed via a hint included in executable code of the computational task that a particular request for data involves accessing and transferring only a subset of data included in a memory cache block. The host processor thus generates a memory request to include a selective transfer hint, which informs other system components (e.g., a memory controller, a memory module, a cache system, and so forth) that only a portion of a cache block is intended to be transferred during the memory access. Thus, in one or more implementations, the host processor also inserts or embeds a hint (e.g., a selective transfer hint) in the memory request as part of generating the memory request.

Alternatively or additionally, in some implementations the executable code for a computational task assigns different regions in memory (e.g., at memory allocation time upon initializing performance of the computational task) to be associated with partial data access, such that the computing system is informed that requests for data from an allocated region in memory correspond to selective data access requests during performance of the computational task. In this manner, upon receiving a request for data that is stored in a designated range of memory addresses, the memory is preemptively informed that the request for data will deviate form a standard amount of data that is typically communicated between system components during a given memory access.

Alternatively or additionally, in some implementations the techniques described herein enable for a dynamic selective data access scenario, where a developer is unable to know which subset of bits from a cache block are needed until runtime. For instance, in many scenarios a developer is unable to know at compile time what specific bits will be stored in a cache block at a given point during execution of a computational task, and must wait until that given point when system components are able to inspect bits of a cache block to identify what is actually stored at each portion of the cache block. In such a deterministic selective data access scenario, the techniques described herein implement a data differentiator unit at one or more system components to inspect a cache block and select an appropriate portion of the cache block to communicate during a memory access while performing a computational task. As a specific example, consider a scenario where a computational task requests 128 bits of a 512-bit cache block during a system memory access. Because a developer of the computational task is unable to know which portion of the cache block will include the requested 128 bits when writing executable code for the computational task, the developer authors the executable code to task a data differentiator unit to analyze the data during runtime and selectively transfer the 128 bits identified during the analysis.

In this specific example, if the data differentiator unit is implemented at a system memory controller, a request for 128 bits of a cache block would first involve retrieving the entire 512-bit cache block from system memory and transmitting the 512-bit cache block to the memory controller. Upon receipt of the cache block, the data differentiator unit of the cache controller analyzes bits of the received cache block to identify a portion of the cache block that corresponds to selectivity parameters for the computational task. In this specific example, consider a scenario where the selectivity parameters specify for retrieval of a 128-bit portion of the cache block that includes the least amount of zeros. As such, the data differentiator unit identifies a 128-bit portion of the cache block that includes the least amount of zeroes and causes the memory controller to output the identified 128-bit portion. Although described herein with respect to specific examples, the selectivity parameters that can be applied to cause selective access and transmission of a cache block portion are not so limited, and the data differentiator unit is configurable to select and transmit any subset size of a cache block based on any parameters authored into executable code for a computational task.

Continuing the example scenario above where the data differentiator unit is tasked with retrieving the 128-bit segment of a 512-bit cache block that includes the least amount of zeroes, while the upstream communication (e.g., the retrieval of the entire 512-bit cache block from system memory to the memory controller implementing the data differentiator unit) involved communicating the entire cache block and thus involved communicating bits of data not needed by a given memory request. However, by implementing the data differentiator unit to identify and select the 128-bit segment including the least amount of zeroes, all downstream communications (e.g., data output from the memory controller to a cache system and data retrieved by a host processor from the cache system for performing the computational task) involve only the selective 128-bit portion of the cache block. In this manner, the techniques described herein enable the system to realize the technical advantages not afforded by conventional system architectures (e.g., decreased power consumption, decreased latency, additional bandwidth, etc.), even in scenarios where a computational task cannot pre-determine (e.g., at memory allocation) which portions of data in memory are to be retrieved at a size that is smaller than a standard data communication size per clock cycle for a system (e.g., less than an entire cache block).

In some aspects, the techniques described herein relate to a system including: a memory controller; a circuit board having memory mounted to the circuit board; and a processor core configured to: generate a memory request for data stored in the mounted memory; transmit the memory request to the circuit board; and in response to transmission of the memory request, cause a subset of a cache block of data to be returned to the processor core.

In some aspects, the techniques described herein relate to a system, wherein the data stored in the mounted memory is stored as a plurality of cache blocks that includes the cache block, wherein each of the plurality of cache blocks is configured as storing a first amount of data, and wherein the subset of the cache block of data includes a second amount of data that is smaller than the first amount of data.

In some aspects, the techniques described herein relate to a system, wherein in response to the processor core transmitting the memory request to the circuit board, the circuit board transmits the cache block of the data to the memory controller and the memory controller transmits the subset of the cache block of data to the processor core.

In some aspects, the techniques described herein relate to a system, further including a cache system, wherein the memory controller is configured to write the subset of the cache block to a cache of the cache system for subsequent access by the processor core.

In some aspects, the techniques described herein relate to a system, wherein in response to the processor core transmitting the memory request to the circuit board, the circuit board transmits the subset of the cache block of data to the memory controller for transmission to the processor core.

In some aspects, the techniques described herein relate to a system, wherein the processor core is further configured to allocate the mounted memory for a computational task that involves accessing the subset of the cache block of data by defining a range of memory addresses as corresponding to a selective access response and the circuit board is caused to return the subset of the cache block of data to the processor core in response to the memory request specifying a memory address included in the range of memory addresses.

In some aspects, the techniques described herein relate to a system, wherein the generation of the memory request further includes embedding a hint in the memory request that defines the subset of the cache block of data to be returned in response to the memory request instead of an entirety of the cache block of data.

In some aspects, the techniques described herein relate to a system, wherein the generation of the memory request further includes embedding selective transfer criteria in the memory request that causes the circuit board to transmit the cache block of data to the memory controller and causes the memory controller to: analyze the cache block of data; identify a subset of data bits that satisfy the selective transfer criteria; and output the subset of data bits that satisfy the selective transfer criteria as the subset of the cache block of data.

In some aspects, the techniques described herein relate to a system, wherein the memory controller is configured to output the subset of data bits that satisfy the selective transfer criteria as the subset of the cache block of data by communicating the subset of the cache block of data to the processor core.

In some aspects, the techniques described herein relate to a system, further including a cache system, wherein the memory controller is configured to output the subset of data bits that satisfy the selective transfer criteria as the subset of the cache block of data by writing the subset of the cache block of data to a cache of the cache system.

In some aspects, the techniques described herein relate to a system, wherein the selective transfer criteria specifies an amount of bits in the cache block that are to be included in the subset of the cache block of data.

In some aspects, the techniques described herein relate to a system, wherein the selective transfer criteria specifies an amount of bits in the cache block that are to be included in the subset of the cache block of data based on a respective bit value of each bit in the cache block.

In some aspects, the techniques described herein relate to a system, further including a cache system, wherein the generation of the memory request further includes embedding selective transfer criteria in the memory request that causes the circuit board to transmit the cache block of data to the cache system and causes the cache system to: analyze the cache block of data; identify a subset of data bits that satisfy the selective transfer criteria; and write the subset of data bits that satisfy the selective transfer criteria to a cache of the cache system as the subset of the cache block of data for subsequent access by the processor core.

In some aspects, the techniques described herein relate to a system, wherein the cache system is further caused to invalidate other bits in the cache block of data that fail to satisfy the selective transfer criteria.

In some aspects, the techniques described herein relate to a device including: a memory controller configured to: receive a cache block of data from a circuit board having memory mounted to the circuit board in response to a memory request from a processor core; identify a subset of data bits in the cache block of data that satisfy a selective transfer criteria included in the memory request; and output the subset of data bits that satisfy the selective transfer criteria to the processor core.

In some aspects, the techniques described herein relate to a device, wherein the cache block includes a first amount of data and wherein the subset of the data bits in the cache block of data that satisfy the selective transfer criteria includes a second amount of data that is smaller than the first amount of data.

In some aspects, the techniques described herein relate to a device, wherein the selective transfer criteria specifies an amount of bits in the cache block that are to be included in the subset of the cache block of data.

In some aspects, the techniques described herein relate to a device, wherein the selective transfer criteria specifies an amount of bits in the cache block that are to be included in the subset of the cache block of data based on a respective bit value of one or more bits in the cache block.

In some aspects, the techniques described herein relate to a device, wherein the memory controller is configured to output the subset of data bits that satisfy the selective transfer criteria by writing the subset of data bits to a cache system that is accessible by the processor core.

In some aspects, the techniques described herein relate to a device including: a processor core configured to: generate a memory request for a subset of a cache block of data stored in memory; transmit the memory request to a circuit board to which the memory is mounted; and cause the circuit board to return the subset of the cache block of data to the processor core in response to receiving the memory request without returning a portion of the cache block of data not included in the subset of the cache block of data.

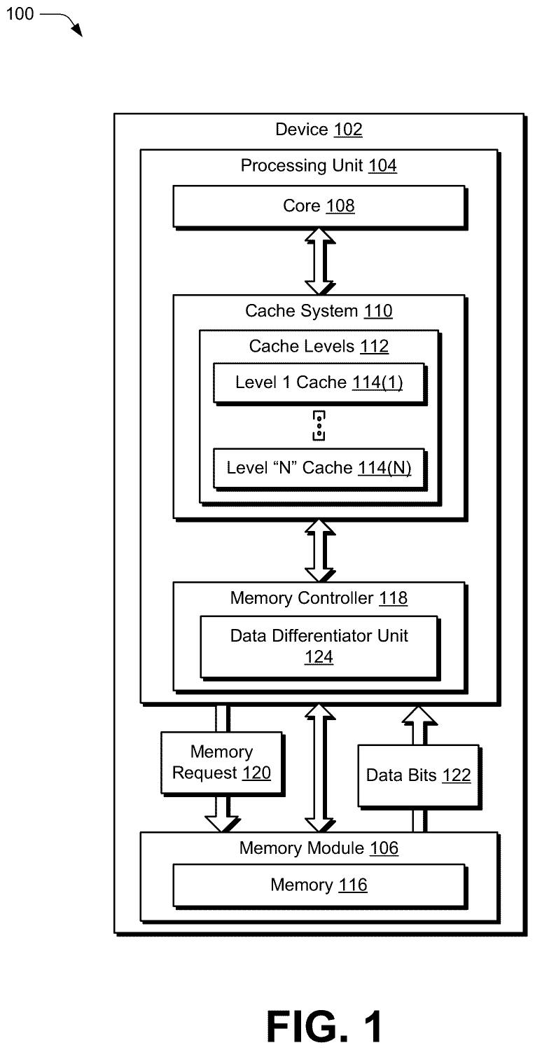

FIG. 1 is a block diagram of a non-limiting example system 100 having a device that implements a processing unit and memory module to implement the selective cache block data transfer techniques described herein. Specifically, the illustrated example of FIG. 1 depicts a device 102 that includes a processing unit 104 and a memory module 106 communicatively coupled with one another (e.g., via at least one bus structure, via a network-on-chip, or any type of interconnect that enables transfer of data between various system components described herein).

The techniques described herein are usable by a wide range of device 102 configurations. Such device configurations include, by way of example and not limitation, computing devices, servers, mobile devices (e.g., wearables, mobile phones, tablets, laptops), processors (e.g., graphics processing units, central processing units, and accelerators), digital signal processors, machine learning inference accelerators, disk array controllers, hard disk drive host adapters, memory cards, solid-state drives, wireless communications hardware connections, Ethernet hardware connections, switches, bridges, network interface controllers, and other apparatus configurations. Additional examples include artificial intelligence training accelerators, cryptography and compression accelerators, network packet processors, and video coders and decoders.

The processing unit 104 includes at least one core 108. The core 108 is an electronic circuit (e.g., implemented as an integrated circuit) that performs various operations on and/or using data in the memory module 106. Examples of processing unit 104 and core 108 configurations include, but are not limited to, a central processing unit (CPU), a graphics processing unit (GPU), a field programmable gate array (FPGA), an accelerated processing unit (APU), and a digital signal processor (DSP). For example, the core 108 is a processing unit that reads and executes instructions (e.g., of a program), examples of which include to add, to move data, and to branch. Although one core 108 is depicted in the illustrated example, in variations, the device 102 includes more than one core 108 (e.g., the device 102 is a multi-core processor). The memory module 106 is implemented as a printed circuit board, on which memory 116 (e.g., physical memory) is disposed (e.g., via physical and communicative coupling using one or more sockets). In other words, the memory 116 is mounted on a printed circuit board and this construction, along with the communicative couplings (e.g., control signals and buses) and one or more sockets integral with the printed circuit board, form the memory module 106. Examples of memory modules include but are not limited to a TransFlash memory module, a single in-line memory module (SIMM), a dual in-line memory module (DIMM), Rambus memory modules which are a subset of DIMMs and are referred to as RIMMs, small outline DIMM which is a smaller version of the DIMM (SO-DIMM), and compression attached memory module, to name just a few. As the memory 116 is mounted to a printed circuit board forming the memory module 106, the memory 116 may be also be interchangeably referred to as mounted memory.

The processing unit 104 includes a cache system 110 having a plurality of cache levels 112, examples of which are illustrated as a level 1 cache 114(1) through a level “N” cache 114(N). The cache system 110 is configured in hardware (e.g., as an integrated circuit) and is communicatively disposed between the processing unit 104 and the memory 116 of the memory module 106. The cache system 110 is configurable as integral with the core 108 as part of the processing unit 104, as a dedicated hardware device as part of the processing unit 104, and so forth. Configuration of the cache levels 112 as hardware is utilized to take advantage of a variety of locality factors. Spatial locality is used to improve operation in situations in which data is requested that is stored physically close to data that is a subject of a previous request. Temporal locality is used to address scenarios in which data that has already been requested will be requested again.

In cache operations, a “hit” occurs to a cache level when data that is subject of a load operation is available via the cache level, and a “miss” occurs when the desired data is not available via the cache level. When employing multiple cache levels, requests are processed through successive cache levels 112 until the data is located. The cache system 110 is configurable in a variety of ways (e.g., in hardware) to address a variety of processing unit 104 configurations, such as a central processing unit cache, graphics processing unit cache, parallel processing unit cache, digital signal processor cache, and so forth.

Examples of the memory module 106 include, but are not limited to, a TransFlash memory module, a single in-line memory module (SIMM), and a dual in-line memory module (DIMM). In one or more implementations, the memory module 106 is a single integrated circuit device that incorporates the memory 116 on a single chip. In some examples, the memory module 106 is formed using multiple chips that implement the memory 116 that are vertically (“3D”) stacked together, are placed side-by-side on an interposer or substrate or are assembled via a combination of vertical stacking or side-by-side placement.

The memory 116 is a device or system that is used to store data, such as for immediate use in a device (e.g., by the core 108). In one or more implementations, the memory 116 corresponds to semiconductor memory where data is stored within memory cells on one or more integrated circuits. In at least one example, the memory 116 corresponds to or includes volatile memory, examples of which include random-access memory (RAM), dynamic random-access memory (DRAM), synchronous dynamic random-access memory (SDRAM), and static random-access memory (SRAM). Alternatively or in addition, the memory 116 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). Access to the memory module 106 for the processing unit 104 is controlled through use of a memory controller 118.

The memory controller 118 is a digital circuit (e.g., implemented in hardware) that manages the flow of data to and from the memory 116 of the memory module 106. By way of example, the memory controller 118 includes logic to read and write to the memory 116. The memory controller 118 also interfaces with the core 108. For instance, the memory controller 118 receives instructions from the core 108. The instructions involve accessing data stored in the memory 116 and providing the data to the core 108 (e.g., for processing by the core 108). In one or more implementations, the memory controller 118 is communicatively located between the core 108 and the memory module 106, such that the memory controller 118 interfaces with the core 108 and the memory module 106.

A specific example of an instruction received by the memory controller 118 to access data maintained in the memory 116 is represented in the illustrated example of FIG. 1 by the memory request 120. The memory request 120, for instance, represents a request made by the processing unit 104 (e.g., by the core 108) for data involved as part of performing one or more operations of a computational task or program. In implementations where the data involved in a computational task is not accessible to the core 108 via the cache system 110, the core 108 transmits the memory request 120 to the memory controller 118, which causes the memory controller 118 to forward the memory request 120 to the memory module 106. The memory request 120 includes information describing one or more bits of data that are maintained in memory 116 (e.g., by specifying a memory address, a range of memory addresses, or combinations thereof) corresponding to locations in the memory module 106 at which the one or more bits of data are stored. In one or more implementations, the core 108 also inserts or embeds a hint (e.g., a selective transfer hint) in the memory request 120 as part of generating the memory request 120. Alternatively or in addition the core 108 inserts or embeds selective transfer criteria in the memory request 120 as part of generating the memory request 120. Incorporating hints and transfer criteria into the memory request 120 are discussed in more detail below.

In conventional systems, a memory request involves requesting an entire cache block of data that includes data bits which are needed to perform a computational task. As a specific example, if a computational task requires eight bytes of data and the system memory is configured using 32-byte cache blocks, a memory request 120 for the requisite eight bytes of data would cause the memory module 106 to respond to the memory request 120 by returning the 32-byte cache block that includes the requisite eight bytes. In contrast to such conventional systems, the techniques described herein configure the memory request 120 to specify that only a portion of a cache block is to be accessed and returned, such that the memory request 120 causes the memory module 106 to return data bits 122, where the data bits 122 represent less than an entirety of a cache block of memory 116, as described in further detail below.

In implementations where it is known at compile time for a given computational task (e.g., known when executable code for the given computational task is being written by a programmer) when a memory request 120 involves selectively accessing and transmitting less than an entirety of a cache block, the executable code is written to include a selective transfer hint for the memory request 120. The selective transfer hint informs various system components (e.g., the cache system 110, the memory controller 118, and the memory module 106) that the memory request 120 involves accessing and transmitting less than an entirety of a cache block, such that the memory module 106 is caused to retrieve data bits 122 from the memory 116 (e.g., rather than an entire cache block that includes the data bits 122). The retrieved data bits 122 are then communicated (e.g., from the memory module 106, to the memory controller 118, to the cache system 110, and finally to the core 108) for use by the core 108 in executing one or more operations of a computational task. By including the selective transfer hint, the different system components and communication channels connecting the different system components are informed as to a deviation from the standard practice of communicating an entire cache block of data in response to a memory request.

In some implementations where it is known at compile time for a computational task when a memory request 120 will involve selective access and transfer of less than an entirety of a cache block, code for a computational task is authored to allocate specific regions of memory as being associated with transferring less than an entirety of a cache block. In this manner, upon receiving a memory request 120 for data maintained at a specified region of memory associated with transferring less than an entirety of the cache block, the memory module 106 is instructed to return only the requested data bits 122 (e.g., rather than the entire cache block that includes the data bits 122).

However, in some implementations it is unknown at compile time for a computational task as to the specific portion of a cache block that will include the requisite bits of data to be requested by a memory request 120 for performing operations of a computational task. For instance, a computational task may be authored to involve processing certain bits of a cache block (e.g., a segment of a cache block that includes the least zeroes, a segment of a cache block that includes the most zeroes, and so forth). However, it is often unknown at compile time for the computational task as to which specific bits of a cache block will include the corresponding data to be requested by the memory request 120 (e.g., which segment of bits in the cache block will include the most zeros, the least zeroes, etc.). Consequently, it is impossible to author a selective transfer hint into executable code for the computational task that accurately identifies the specific bits of a cache block to be requested by the memory request 120.

To address this problem and account for selective data access and transfer scenarios where it is unknown as to what portion of a cache block should be accessed and transferred until runtime for a computational task, the system 100 implements a data differentiator unit 124. The data differentiator unit 124 represents functionality of the device 102 to consider selective transfer criteria associated with the memory request 120 (e.g., return only 128 bits of a 512-bit cache block based on respective bit values of the cache block), analyze a cache block based on the selective transfer criteria during runtime (e.g., during execution) of a computational task, and return the requested subset of the cache block based on the selective transfer criteria.

For instance, consider an example scenario where the memory request 120 includes selective transfer criteria that instructs for a certain 128-bit portion of a 512-bit cache block to be returned. In this example scenario, the memory request 120 would cause an entire 512-bit cache block (e.g., corresponding to a memory address specified in the memory request 120) to be retrieved from memory and returned to the memory controller 118. Upon receipt of the 512-bit cache block, the memory controller 118 implements the data differentiator unit 124 and causes the data differentiator unit 124 to analyze the cache block based on the selective transfer criteria (e.g., to identify the corresponding 128-bit portion of the 512-bit cache block) and return the identified 128-bit portion to the cache system 110. In this manner, the described techniques enable for selective access and transfer of less than an entirety of data stored in a cache block in response to a memory request, even in scenarios where the specific cache block subset to be returned in response to a memory request is unknown until after beginning execution of a computational task.

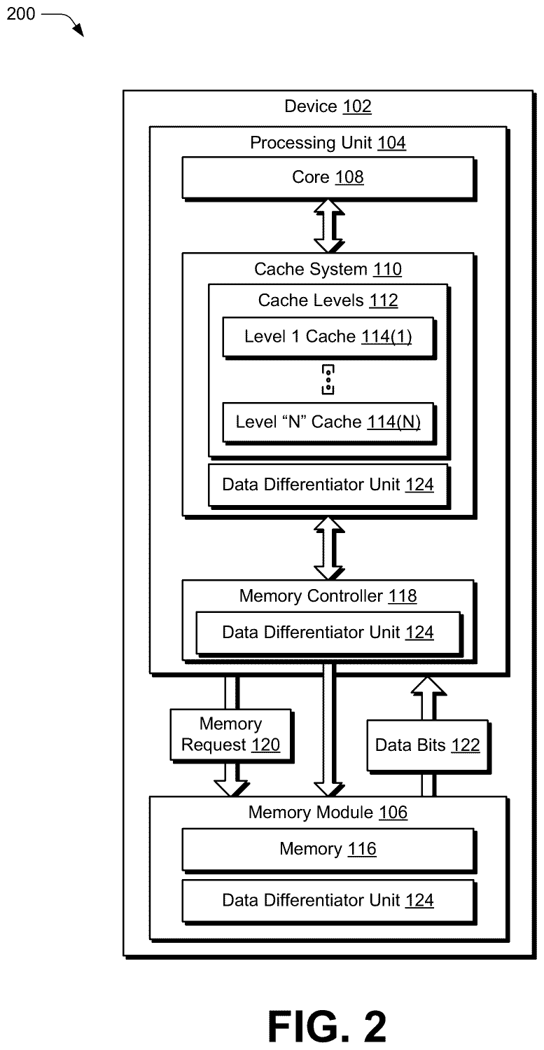

Although depicted in the illustrated example of FIG. 1 as being implemented at the memory controller 118, the data differentiator unit 124 is configured for implementation at any suitable system component in accordance with the described techniques. For instance, FIG. 2 is a block diagram of a non-limiting example system 200 showing the device of FIG. 1 in greater detail as employing a data differentiator unit at one or more device components to implement the selective cache block data transfer techniques described herein.

As depicted in the illustrated example of FIG. 2, different instances of the data differentiator unit 124 are implemented at the cache system 110, the memory controller 118, and the memory module 106. In this manner, the deterministic selective access and transfer of less than an entirety of a cache block in response to a memory request 120 (e.g., based on selective transfer criteria associated with the memory request 120) during runtime for a computational task, based on analysis of data included in a cache block, can be performed by any one or more of the described system components. Thus, although described herein in the context of being implemented at a specific system component (e.g., at the memory controller 118) for simplicity, functionality of the data differentiator unit 124 is performable by any system component implementing the data differentiator unit 124. In this manner, the data differentiator unit 124 is representative of an integrated circuit configured to analyze a cache block of data based on selective transfer criteria associated with a memory request and return a subset of the cache block as specified by the selective transfer criteria.

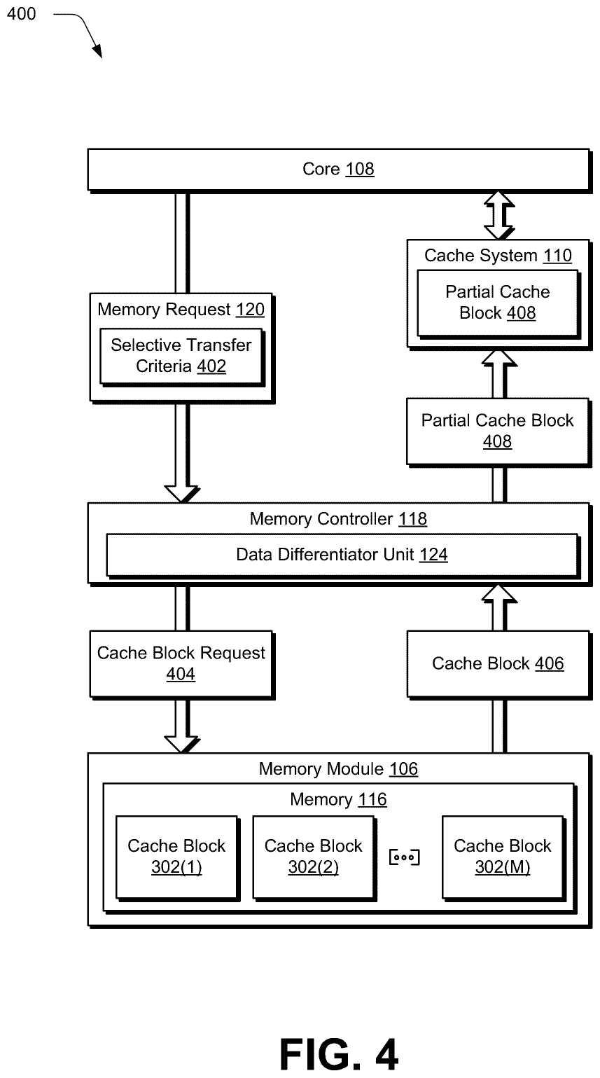

For instance, in implementations where the data differentiator unit 124 is implemented at the cache system 110, the data differentiator unit 124 is caused to analyze a cache block based on selective transfer criteria associated with a memory request that caused output of the cache block from memory 116 to the cache system 110. Continuing the above example where the selective transfer criteria instructs the data differentiator unit 124 to identify and return a certain 128-bit portion of the 512-bit cache block n, when implemented at the cache system 110, the data differentiator unit 124 writes the identified 128-bit portion to a cache 114 and invalidate other bits of the 512-bit cache block that fail to satisfy the selective transfer criteria. Functionality of the data differentiator unit 124 is described in further detail below with respect to FIG. 4.

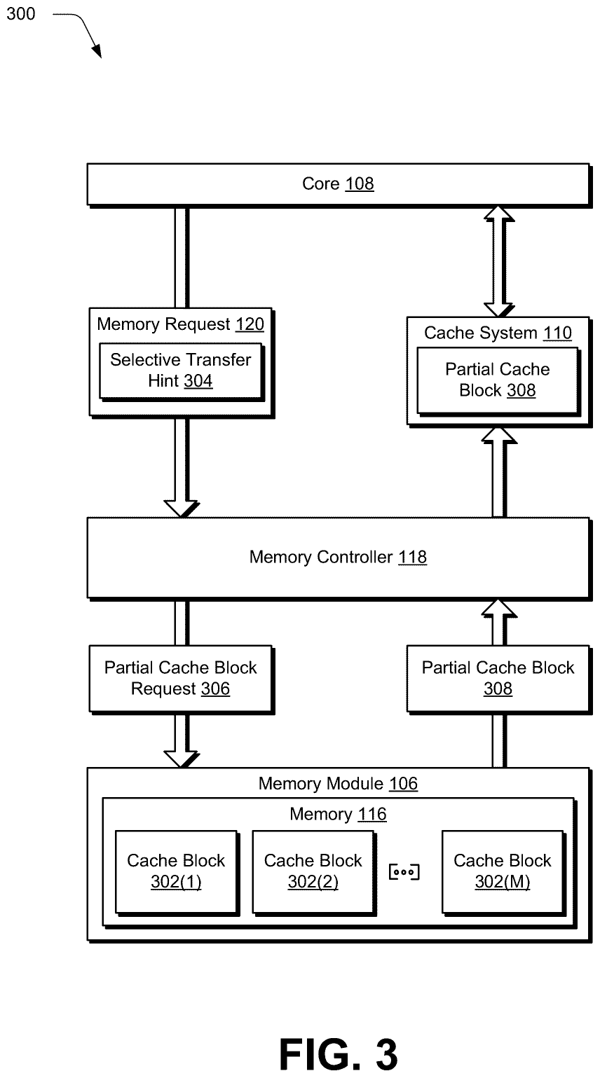

FIG. 3 is a block diagram of a non-limiting example system 300 showing operation of a memory controller of FIG. 1 in greater detail as generating a partial cache block request based on a selective transfer hint included in a memory request. In the illustrated example of FIG. 3, the memory 116 is depicted as being organized by storing data in a plurality of cache blocks, examples of which are illustrated as cache block 302(1), cache block 302(2), . . . , cache block 302(M), where M represents any integer. Each cache block represents a contiguous range of addresses and associated data that is stored within the memory 116. In implementations, the size of a cache block is typically multiple bytes (e.g., ranging from a few bytes to a few hundred bytes), and is dependent on an architecture of the system implementing the memory module 106 (e.g., 32-byte cache blocks, 64-byte cache blocks, 128-byte cache blocks, and so forth). Although described herein with respect to specific example sizes, the size of a cache block 302 is configurable to include any amount of data in accordance with the described techniques.

In the illustrated example of FIG. 3, the core 108 is depicted as generating and transmitting a memory request 120 that includes a selective transfer hint 304. The selective transfer hint 304 is representative of information indicating that less than an entirety of a cache block 302 is to be returned to the core 108 in response to the memory request 120. In implementations, a developer of a computer application (i.e., a computational task to be executed by the system 300) writes executable code of the computer application to define when a particular memory request 120 is to deviate from a standard expectation of returning an entire cache block 302 in response to a memory request 120 that requests a portion of data included in the cache block 302. For instance, in an implementation where it is known at compile time (e.g., before execution of the computational task by the system 300) as to when a particular memory request 120 is intended to return a specific subset of data bits included in a cache block 302, a developer can write the executable code such that the selective transfer hint 304 is included in the particular memory request 120.

Alternatively or additionally, in some implementations the executable code of a computational task is written such that a range of addresses in memory 116 are allocated to indicate that a memory request 120 for data included in the range of memory addresses is intended to return only the specific bits of data requested by the memory request 120. For instance, executable code for a computational task is written such that upon memory allocation for the computational task, the memory 116 is allocated to define any request for data from a memory address range spanning the cache block 302(1) and the cache block 302(2) to indicate that less than an entirety of the respective cache block should be returned in response to a memory request 120 for data stored in the corresponding cache block. In such implementations, the memory module 106 is informed at the time of memory allocation that any memory request 120 for data having an address encompassed by the range of memory addresses included in the cache block 302(1) and the cache block 302(2) should be treated as having a selective transfer hint 304, even if such a selective transfer hint 304 is not explicitly included in the memory request 120. In a similar manner, the memory controller 118 is informed upon memory allocation that any requests for data corresponding to a range of memory addresses allocated for returning only a portion of a cache block 302 should not cause return of an entire cache block 302 that includes data requested by the device 102.

Given such selective data transfer information (e.g., via the explicit selective transfer hint 304 included in a memory request 120, via memory allocation defining a range of memory addresses for which memory requests 120 are not to return an entire cache block 302, or combinations thereof), the memory controller 118 is configured to forward the memory request 120 as a partial cache block request 306 to the memory module 106. The partial cache block request 306 is representative of the memory request 120 with instructions for the memory module 106 to return only bits of data that are requested by the memory request 120, rather than an entirety of a cache block 302 that includes the bits of data requested by the memory request 120.

In the illustrated example of FIG. 3, the specific bits of data requested by the memory request 120 are depicted as the partial cache block 308. The partial cache block 308 represents a subset of bits of data included in one of the cache blocks 302(1)-(M), where each cache block 302 includes a first size of data and the partial cache block 308 includes a second size of data that is smaller than the first size of data (e.g., fewer than all data bits maintained in a cache block 302). The memory controller 118 is configured to write the partial cache block 308 to one or more caches 114 of the cache system 110 for subsequent access by the core 108.

In this manner, the described techniques avoid the energy consumption and bandwidth requirements of conventional system architectures, which would involve communicating an entire cache block 302 of data from the memory module 106, to the memory controller 118, and finally to the cache system 110 so that the core 108 can read the partial cache block 308 from the entire cache block 302 that was written to the cache system 110. Thus, the techniques described herein optimize energy consumption and avoid unnecessarily transmitting data between system components in scenarios where a memory request 120 for a computational task involves only a subset of data maintained in a given cache block 302.

In some implementations, however, it is unknown before runtime (e.g., before beginning execution of a computational task) as to which specific portion of a cache block 302 will include the data bits to be returned as the partial cache block 308 in response to the memory request 120. For instance, the memory request 120 may involve returning bits of a cache block 302 that are updated based on earlier-performed operations of the computational task, where the bit values cannot be known or otherwise guaranteed with any degree of accuracy until the earlier operations of the computational task have finished performing. To account for such implementations, the techniques described herein include generating a memory request to include selective transfer criteria that is useable at runtime (e.g., during execution of a computational task) to identify which portion of a cache block 302 should be returned as the partial cache block 308 in response to the memory request 120. For a further description of leveraging selective transfer criteria to return a cache block subset from memory in response to a memory request, consider FIG. 4.

FIG. 4 is a block diagram of a non-limiting example system 400 showing operation of a memory controller of FIG. 1 in greater detail as returning a partial cache block in response to a memory request based on analysis of data included in a cache block retrieved from memory. As noted above, although described herein and illustrated in FIG. 4 as being implemented at the memory controller 118, functionality of the data differentiator unit 124 to analyze and identify a portion of a cache block to return in response to a memory request 120 is configured for implementation at any one or combination of system components, such as at the memory module 106, the cache system 110, the memory controller 118, or combinations thereof.

In the illustrated example of FIG. 4, the core 108 is depicted as generating and transmitting a memory request 120 for data to the memory controller 118 for use in performing one or more operations of a computational task. The memory request 120 is depicted as including selective transfer criteria 402, which is representative of information defining one or more criteria (e.g., parameters, threshold values, etc.) by which data stored in a cache block 302 is to be analyzed and selected for transmission to the core 108 (e.g., instead of transmitting the cache block 302 in its entirety). By including the selective transfer criteria 402 in a memory request 120, a developer of a computational task is able to define how the memory request 120 should cause transmission of only a portion of a cache block 302, instead of an entirety of the cache block 302 as performed by conventional systems, based on specific values of data bits included in the cache block 302.

Advantageously, the selective transfer criteria 402 enables for a developer to cause the memory request 120 to return the portion of the cache block 302 that satisfies requirements of the selective transfer criteria 402 (e.g., based on values of data bits included in the cache block 302), without prior knowledge of what data bit values in the cache block 302 will be upon issuance of the memory request 120. For instance, in some implementations performing an operation of a computational task might involve processing only 128 bits of a cache block that includes 512 bits (e.g., a 128-bit segment of a cache block 302 that includes the least amount of zeroes, relative to different possible 128-bit segments of the cache block 302). However, because specific values of each data bit included in the cache block 302 cannot be known prior to beginning execution of the computational task, executable code for the computational task is written to include a selective transfer criteria 402 for the memory request that causes analysis of specific bit values in a cache block at runtime, so that the appropriate 128-bit segment is returned in response to the memory request 120.

In such a specific example scenario where the selective transfer criteria 402 specifies for a subset of the cache block 302(1) to be returned in response to the memory request 120, the memory controller 118 transmits a cache block request 404 to the memory controller 118 for the entire cache block 302(1). The entire cache block 302(1) (e.g., all 512 bits of data represented by the cache block 302(1)) is then returned to the memory controller 118 as cache block 406 in response to the cache block request 404. By implementing the data differentiator unit 124 at the memory controller 118, the memory controller 118 is caused to analyze the cache block 406 to identify which portion of the cache block 406 satisfies the selective transfer criteria 402 for the memory request 120 (e.g., which 128-bit segment included in the cache block 406 includes the fewest amount of zeroes).

By analyzing the cache block 406 according to the selective transfer criteria 402, the data differentiator unit 124 is caused to output a partial cache block 408 (e.g., instead of the entire cache block 406) to the cache system 110 for subsequent access by the core 108. In this manner, the partial cache block 408 is representative of a portion of data included in the cache block 406 that satisfies the selective transfer criteria 402, where other data include in the cache block 406 that does not satisfy the selective transfer criteria 402 is not communicated downstream from the data differentiator unit 124 (e.g., not written to the cache system 110 or otherwise communicated to the core 108). For instance, continuing the specific example scenario described above, the partial cache block 408 represents the 128-bit segment of the cache block 406 that includes the fewest zeroes. As another specific example, in some implementations the selective transfer criteria 402 identifies one or more address ranges in memory 116 from which the partial cache block 408 is to be returned instead of the entire cache block 406, such that the data differentiator unit 124 is programmed to identify that requests for data corresponding to the one or more address ranges will deviate from accessing the entire cache block 406.

In this manner, the described techniques avoid the energy consumption and bandwidth requirements of conventional system architectures, which would involve communicating the entire cache block 406 from the memory module 106 to the memory controller 118 as well as writing the entire cache block 406 to the cache system 110 (e.g., so that the core 108 could later analyze the cache block 406 as maintained in the cache system 110 and select to access only the requisite partial cache block 408 needed for a computational task). Thus, the techniques described herein optimize energy consumption and avoid unnecessarily transmitting data between system components in scenarios where a memory request 120 for a computational task involves only a subset of data maintained in a given cache block 302, even in scenarios where it is unknown as to the specific location (e.g., addresses in memory 116) where the subset of the cache block 302 will be maintained before runtime for the computational task.

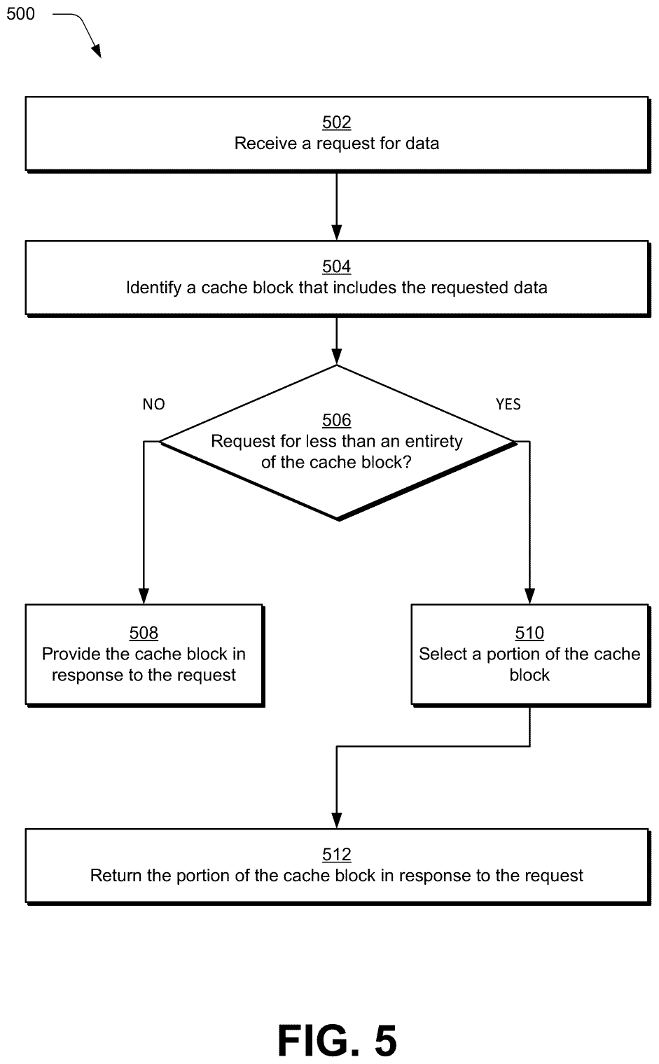

FIG. 5 is a block diagram of a non-limiting example procedure 500 describing performance of a stepwise algorithm that provides structure for selectively transferring a portion of data included in a cache block in response to a memory request.

To begin, a request for data is received (block 502). The memory controller 118, for instance, receives a memory request 120 from the core 108. A cache block is then identified that includes the requested data (block 504). The memory controller 118, for instance, identifies at least one memory address included in the memory request 120 and identifies a correspond cache block 302 in memory 116 that includes the at least one memory address corresponding to the data requested by the memory request 120.

A determination is then made as to whether the memory request is for less than an entirety of data stored in the cache block (block 506). The memory controller 118, for instance, is informed as to situations when the memory request 120 is for less than an entirety of data included in a cache block 302 when the memory request 120 includes a selective transfer hint 304 or includes selective transfer criteria 402. In response to determining that the memory request is not for less than an entirety of the cache block (e.g., a “No” determination at block 506), the cache block is provided in response to the request (block 508). For instance, in response to the memory request 120 not including a selective transfer hint 304 or selective transfer criteria 402, the memory controller 118 forwards the memory request 120 to the memory module 106 in a manner that causes the memory module 106 to return the entire cache block 302 that includes data requested by the memory request 120, responsive to receiving the memory request 120. For instance, the memory module 106 outputs an entire cache block 302 including data requested by the memory request 120 to the memory controller 118, to the cache system 110, to the core 108, or combinations thereof.

Alternatively, in response to determining that the memory request is for less than an entirety of a cache block (e.g., a “Yes” determination at block 506), a portion of the cache block is selected for the memory request (block 510). In implementations where the memory request 120 includes a selective transfer hint 304, for instance, the memory controller 118 communicates a partial cache block request 306 to the memory module 106 that instructs the memory module 106 to return only the specific bits of data requested by the memory request 120, rather than an entirety of a cache block 302 that includes the specific bits of data requested by the memory request. In implementations where the memory controller 118 generates a partial cache block request 306, the memory module 106 is caused to return the partial cache block 308 to the memory controller 118, which includes only bits of data specifically requested by the memory request 120.

Alternatively, in implementations where the memory request 120 includes a selective transfer criteria 402, the memory controller 118 transmits a cache block request 404 to the memory module 106 which causes the memory module 106 to return the cache block 406 to the memory controller 118. The memory controller 118 then implements a data differentiator unit 124 to analyze the cache block 406 based on the selective transfer criteria 402 of the memory request 120 and identify a partial cache block 408 that includes the specific bits of data requested by the memory request 120.

The portion of the cache block is then returned in response to the request (block 512). The memory module 106, for instance, outputs the partial cache block 308 in response to the partial cache block request 306. Alternatively, the data differentiator unit 124 outputs the partial cache block 408 by selecting a portion of the cache block 406 that satisfies the selective transfer criteria 402 for the memory request 120.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the device 102 having the core 108 and the memory module 106 having the memory 116) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A system comprising:
a memory controller;
a circuit board having memory mounted to the circuit board; and
a processor core configured to:
generate a memory request for data stored in the mounted memory;
transmit the memory request to the circuit board; and
in response to transmission of the memory request, cause a subset of a cache block of data to be returned to the processor core.

2. The system of claim 1, wherein the data stored in the mounted memory is stored as a plurality of cache blocks that includes the cache block, wherein each of the plurality of cache blocks is configured as storing a first amount of data, and wherein the subset of the cache block of data comprises a second amount of data that is smaller than the first amount of data.

3. The system of claim 1, wherein in response to the processor core transmitting the memory request to the circuit board, the circuit board transmits the cache block of the data to the memory controller and the memory controller transmits the subset of the cache block of data to the processor core.

4. The system of claim 3, further comprising a cache system, wherein the memory controller is configured to write the subset of the cache block to a cache of the cache system for subsequent access by the processor core.

5. The system of claim 1, wherein in response to the processor core transmitting the memory request to the circuit board, the circuit board transmits the subset of the cache block of data to the memory controller for transmission to the processor core.

6. The system of claim 1, wherein the processor core is further configured to allocate the mounted memory for a computational task that involves accessing the subset of the cache block of data by defining a range of memory addresses as corresponding to a selective access response and the circuit board is caused to return the subset of the cache block of data to the processor core in response to the memory request specifying a memory address included in the range of memory addresses.

7. The system of claim 1, wherein the generation of the memory request further includes embedding a hint in the memory request that defines the subset of the cache block of data to be returned in response to the memory request instead of an entirety of the cache block of data.

8. The system of claim 1, wherein the generation of the memory request further includes embedding selective transfer criteria in the memory request that causes the circuit board to transmit the cache block of data to the memory controller and causes the memory controller to:
analyze the cache block of data;
identify a subset of data bits that satisfy the selective transfer criteria; and
output the subset of data bits that satisfy the selective transfer criteria as the subset of the cache block of data.

9. The system of claim 8, wherein the memory controller is configured to output the subset of data bits that satisfy the selective transfer criteria as the subset of the cache block of data by communicating the subset of the cache block of data to the processor core.

10. The system of claim 8, further comprising a cache system, wherein the memory controller is configured to output the subset of data bits that satisfy the selective transfer criteria as the subset of the cache block of data by writing the subset of the cache block of data to a cache of the cache system.

11. The system of claim 8, wherein the selective transfer criteria specifies an amount of bits in the cache block that are to be included in the subset of the cache block of data.

12. The system of claim 8, wherein the selective transfer criteria specifies an amount of bits in the cache block that are to be included in the subset of the cache block of data based on a respective bit value of each bit in the cache block.

13. The system of claim 1, further comprising a cache system, wherein the generation of the memory request further includes embedding selective transfer criteria in the memory request that causes the circuit board to transmit the cache block of data to the cache system and causes the cache system to:
analyze the cache block of data;
identify a subset of data bits that satisfy the selective transfer criteria; and
write the subset of data bits that satisfy the selective transfer criteria to a cache of the cache system as the subset of the cache block of data for subsequent access by the processor core.

14. The system of claim 13, wherein the cache system is further caused to invalidate other bits in the cache block of data that fail to satisfy the selective transfer criteria.

15. A device comprising:
a memory controller configured to:
receive a cache block of data from a circuit board having memory mounted to the circuit board in response to a memory request from a processor core;
identify a subset of data bits in the cache block of data that satisfy a selective transfer criteria included in the memory request; and
output the subset of data bits that satisfy the selective transfer criteria to the processor core.

16. The device of claim 15, wherein the cache block comprises a first amount of data and wherein the subset of the data bits in the cache block of data that satisfy the selective transfer criteria comprises a second amount of data that is smaller than the first amount of data.

17. The device of claim 15, wherein the selective transfer criteria specifies an amount of bits in the cache block that are to be included in the subset of the cache block of data.

18. The device of claim 15, wherein the selective transfer criteria specifies an amount of bits in the cache block that are to be included in the subset of the cache block of data based on a respective bit value of one or more bits in the cache block.

19. The device of claim 15, wherein the memory controller is configured to output the subset of data bits that satisfy the selective transfer criteria by writing the subset of data bits to a cache system that is accessible by the processor core.

20. A device comprising:
a processor core configured to:
generate a memory request for a subset of a cache block of data stored in memory;
transmit the memory request to a circuit board to which the memory is mounted; and
cause the circuit board to return the subset of the cache block of data to the processor core in response to receiving the memory request without returning a portion of the cache block of data not included in the subset of the cache block of data.
